(19) United States
(12) Patent Application Publication
(10) Pub. No.: US 2021/0264826 A1
(43) Pub. Date: Aug. 26, 2021

(54) PRODUCTS FOR ADHERING TO A VEHICLE USING ADHESIVES AND/OR MAGNETS THAT INCORPORATE A FLAP ELEMENT

(71) Applicant: Christina Coe, Greenfield, IN (US)

(72) Inventor: Christina Coe, Greenfield, IN (US)

(21) Appl. No.: 17/182,086

(22) Filed: Feb. 22, 2021

Related U.S. Application Data
(60) Provisional application No. 62/980,126, filed on Feb. 21, 2020.

(51) Int. Cl. G09F 21/04; G09F 7/18

(52) U.S. Cl. CPC G09F 21/046; G09F 7/18; G09F 2007/1873; G09F 2007/1852; G09F 21/041

(57) ABSTRACT

Products for adhering to a vehicle using adhesives and/or magnets that incorporate a flap element. An exemplary product configured to adhere to a vehicle disclosed herein comprises an adherent portion, and a flap element coupled to or formed as part of the adherent portion, wherein the adherent portion is configured to adhere to a vehicle, and wherein the flap element is configured to flap in the wind while the vehicle is moving

### PRIORITY

The present application is related to, and claims the priority benefit of, U.S. Provisional Patent Application Ser. No. 62/980,126, filed Feb. 21, 2020, the contents of which are incorporated herein in their entirety.

### BACKGROUND

Traditional bumper stickers or vehicle magnets are configured to be completely secured to a vehicle. For example, a traditional bumper sticker has an adhesive on 100% of the portion of the sticker so to fully adhere to the vehicle. A traditional “car magnet” comprises a magnetic portion that exists on 100% of the surface intended to adhere to the vehicle. Furthermore, said traditional bumper stickers and car magnets have a flat exterior surface that compliments the flat interior surface configured to adhere to part of the vehicle.

As such, traditional bumper stickers and car magnets are not configured to have a portion thereof not adhered to the vehicle, whereby said portion is configured to flap in the wind, such as when a vehicle having the sticker or magnet is in motion.

A product, configured to adhere to a vehicle, having a portion thereof configured to flap in the wind, such as when a vehicle having the sticker or magnet is in motion, would be well received in the marketplace.

### BRIEF SUMMARY

The present disclosure includes disclosure of products configured as modified novel bumper stickers or modified novel magnetic items, namely products that can adhere to a portion of a vehicle, using an adhesive and/or one or more magnets, to securely adhere said product to the vehicle.

The present disclosure includes disclosure of a product configured to adhere to a vehicle, comprising an adherent portion, and a flap element coupled to or formed as part of the adherent portion, wherein the adherent portion is configured to adhere to a vehicle, and wherein the flap element is configured to flap in the wind while the vehicle is moving.

The present disclosure includes disclosure of a product configured to adhere to a vehicle, wherein the adherent portion comprises one or more adhesives.

The present disclosure includes disclosure of a product configured to adhere to a vehicle, wherein the adherent portion comprises one or more magnets.

The present disclosure includes disclosure of a product configured to adhere to a vehicle, wherein the adherent portion comprises one or more adhesives and one or more magnets.

The present disclosure includes disclosure of a product configured to adhere to a vehicle, wherein the adherent portion has indicia upon an outer surface of the adherent portion, and wherein the one or more adhesives are present upon an inner surface intended to contact the vehicle.

The present disclosure includes disclosure of a product configured to adhere to a vehicle, wherein the adherent portion has indicia upon an outer surface of the adherent portion, and wherein the one or more magnets are present upon an inner surface intended to contact the vehicle.

The present disclosure includes disclosure of a product configured to adhere to a vehicle, configured such that the flap element comprises hair or fur.

The present disclosure includes disclosure of a product configured to adhere to a vehicle, comprising an adherent portion comprising an adherent selected from the group consisting of one or more adhesives and one or more magnets, and a flap element coupled to or formed as part of the adherent portion, wherein the adherent portion is configured to adhere to a vehicle, wherein the flap element does not have one or more adhesives or one or more magnets that would cause the flap element to adhere to the vehicle, and wherein the flap element is configured to flap in the wind while the vehicle is moving.

The present disclosure includes disclosure of a method, comprising the steps of adhering an exemplary product of the present disclosure to a vehicle, and driving the vehicle to cause the flap element to flap in the wind while the vehicle is moving.

The present disclosure includes disclosure of products, as described and/or shown herein.

The present disclosure includes disclosure of products configured to adhere to a vehicle, using one or more adhesives and/or one or more magnets, and having a flap element coupled thereto or formed as part of the products, whereby the flap element is configured to flap in the wind/air/breeze while the vehicle is moving.

The present disclosure includes disclosure of methods of making exemplary products of the present disclosure.

The present disclosure includes disclosure of methods of using exemplary products of the present disclosure.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, whereby said figures show exemplary products configured to adhere to a vehicle, using an adhesive or one or more magnets, with an element thereof configured to flap in the wind.

FIG. 1 shows a front or outer view product configured to adhere to a vehicle or another substrate, according to an exemplary embodiment of the present disclosure;

FIG. 2 shows a back or inner view product configured to adhere to a vehicle or another substrate, having one or more adhesives positioned thereon, according to an exemplary embodiment of the present disclosure;

FIG. 3 shows a back or inner view product configured to adhere to a vehicle or another substrate, having one or more magnets positioned thereon, according to an exemplary embodiment of the present disclosure;

FIG. 4 shows a front or outer view product configured to adhere to a vehicle or another substrate, whereby the product has indicia thereon, according to an exemplary embodiment of the present disclosure; and

FIG. 5 shows a perspective view of a product, whereby the flap element is depicted (with the “movement lines”) as flapping while the adhesive portion remains adhered to a vehicle, according to an exemplary embodiment of the present disclosure.

As such, an overview of the features, functions and/or configurations of the components depicted in the various figures will now be presented. It should be appreciated that not all of the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

As noted above, the present disclosure includes disclosure of products configured as modified novel bumper stickers or modified novel magnetic items, namely products that can adhere to a portion of a vehicle, using an adhesive and/or one or more magnets, to securely adhere said product to the vehicle.

The present disclosure includes disclosure of a product configured to adhere to a vehicle, using one or more adhesives and/or one or more magnets, and having a flap element coupled thereto or formed as part of the product, whereby the flap element is configured to flap in the wind/air/breeze while the vehicle is moving.

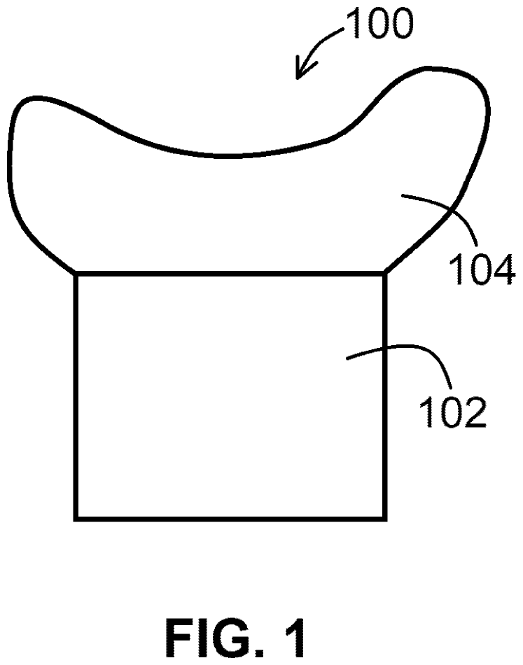

As shown in the figures (see FIG. 1 for example), an exemplary product 100 of the present disclosure is configured as a product configured for placement upon a portion of a vehicle, such as a bumper, tailgate, trunk, door, roof, hood, etc. Traditional bumper stickers or vehicle magnets are configured to be completely secured to a vehicle. For example, a traditional bumper sticker has an adhesive on 100% of the portion of the sticker so to fully adhere to the vehicle. A traditional “car magnet” comprises a magnetic portion that exists on 100% of the surface intended to adhere to the vehicle. Furthermore, said traditional bumper stickers and car magnets have a flat exterior surface that compliments the flat interior surface configured to adhere to part of the vehicle.

An exemplary product 100 of the present disclosure, such as shown in FIG. 1, comprises an adherent portion 102 and a flap element 104 coupled thereto or formed as part thereof, whereby the flap element 104 is configured to flap in the wind/air/breeze while the vehicle is moving.

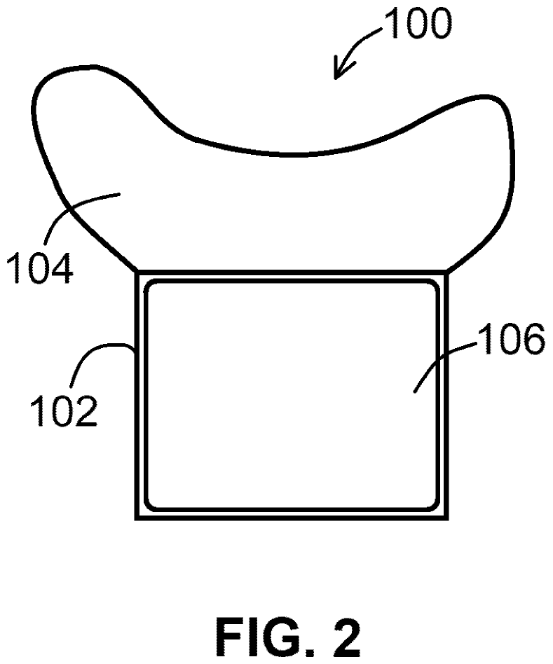

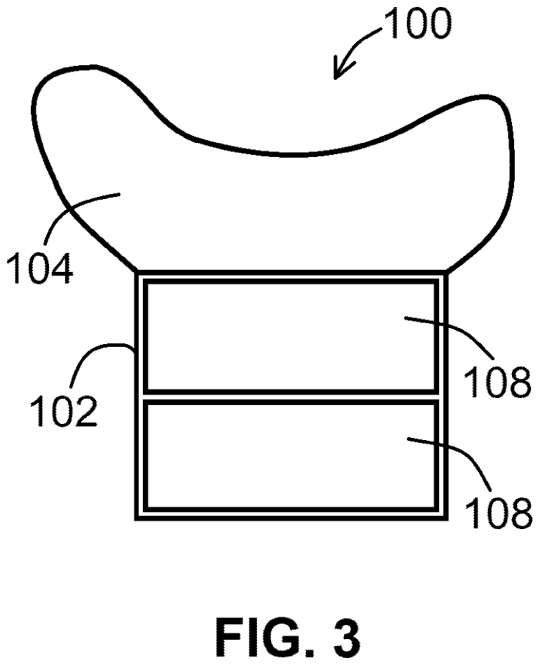

In at least one product 100 embodiment of the present disclosure, the product 100 has an adherent portion 102 as part of said product 100, whereby the adherent portion 102 includes or comprises one or more adhesives 106, such as shown in FIG. 2, and/or one or more magnets 108, such as shown in FIG. 3. Said adherent portion 102 can cover some, most, or all of a surface of the adherent portion 102 intended to adhere to the vehicle.

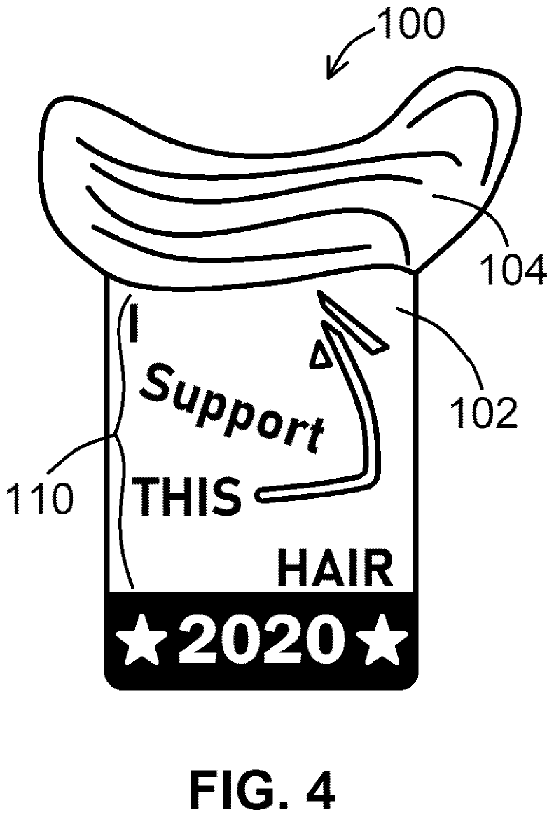

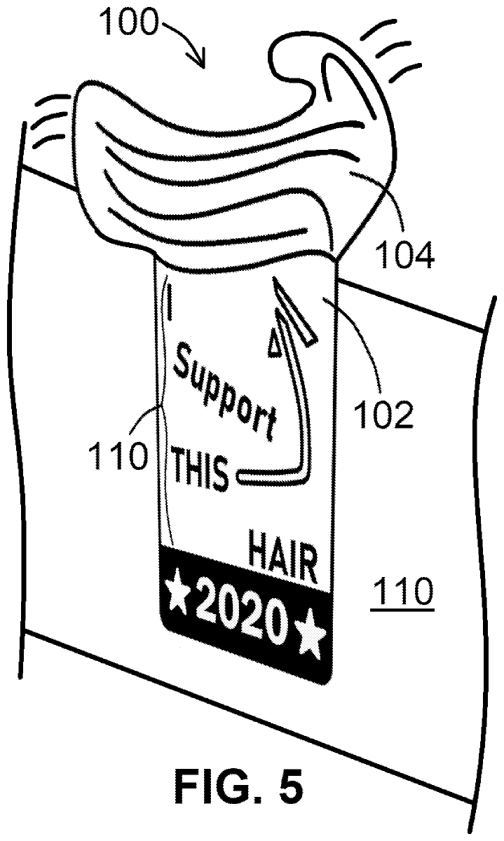

In product 100 embodiments whereby the adherent portion 102 covers 100% of the surface intended to adhere to a portion of a vehicle, said product 100 further comprises a flap element 104 coupled thereto or formed as part of said product 100. The flap element 104 is intended to flap (move in various directions) when the vehicle is in motion, due to air flow in the vicinity of said product 100. In such an embodiment, an entirety of the surface of the adherent portion 102 adheres to the vehicle, while the flap element 104, coupled to or formed as part of the product 100, is permitted to flap in the wind. Said products 100 can be made by placing an adhesive 106 on one side of the product 100 (namely at the adherent portion 102), and including a flap element 104 coupled thereto or formed as part thereof. Indicia 110 (letters, numbers, words, shapes, images, etc.) can appear on the side of the product 100 opposite the adhesive side (the back of the adherent portion 102) and/or on the flap element 104, such as shown in FIG. 4. As shown in FIGS. 4 and 5, the flap element 104 is configured to resemble hair, and can be made using real or fake hair or fur, for example.

Other product 100 embodiments of the present disclosure can have an adherent portion 102 that covers less than 100% of the surface of the adherent portion 102. In such an embodiment, the remainder (likely the majority) of the adherent surface can adhere to the vehicle, while the flap element 104 would also either contact the vehicle (so to be adjacent to part of the adherent surface), or would be coupled to or formed as part of the product 100. The flap element 104 itself would either partially or fully not have an adhesive 106 thereon and/or would partially or fully not have a magnet (magnetic portion or element) as part thereof—this is so that at least part of the flap element 104 not having the adhesive 106 or magnet 108 is able to flap in the wind and not itself fully adhere to the vehicle (which would prevent flapping). Said products 100 can be made by adhering a face portion to a magnetic adherent portion 102, and including a flap element 104 coupled thereto or formed as part thereof, with indicia 110 on the face portion (the relative “front” of the product 100) and/or on the flap element 104. Other embodiments may not have a face portion, and include a magnetic adherent portion 102 and a flap element 104 coupled thereto or formed as part thereof, with indicia 110 on the magnetic adherent portion 102 and/or on the flap element 104.

At least one purpose of the flap element 104 would be to be more readily seen, be easier to see, be better able to get the attention of a viewer, etc., as compared to a traditional bumper sticker or car magnet that does not have a flap element 104 that moves in the wind.

In some embodiments of products 100 of the present disclosure, the products 100 are vinyl (or other polymeric material) products 100, similar to traditional bumper stickers, whereby an adhesive 106 is placed/present on one side and indicia 110 is present on the outside (opposite side). In other embodiments, the products 100 comprise a magnetic adherent portion 102 (so a thin magnet) and a face portion coupled thereto, whereby the face portion can have the indicia 110 thereon that is intended to be viewed on the outside of a vehicle. In other embodiments, the products 100 comprise (either partially or fully) a fabric material, such like a thin cloth used to make vehicle flags), whereby the adherent portion 102 is coupled to or formed as part of the fabric material product 100.

Products 100 of the present disclosure, in various embodiments, can be considered as being waving, flying, moving, flapping, etc., modified novel bumper stickers or modified novel car magnets. Products 100 of the present disclosure can be designed as, having indicia 110 of, etc., various sports team indicia 110, country flags, arrows for left lane drivers and people who do not use turn signals, political information, cartoon characters, etc.—any sort of indicia 110 or designs known or developed in the art. The flap element 104 can be of various sizes and/or shapes, such as rectangular for flags, curved like mouse ears, etc., and can comprise any number of materials, such as a hair-like material as shown in the figures.

Exemplary products 100 of the present disclosure can be designed in such a fashion that the possibilities to observe the process by which part of the sticker (flap element 104 of an exemplary product 100) is made airborne and does not have a sticker or magnetic backing, and the other half (adherent portion 102 of an exemplary product 100) does have a sticker or magnetic backing, so that it can stick to a vehicle 110 or another object. Each time a gust of wind appears, or while the vehicle 110 is traveling, the non-sticking part of the product 100, waves automatically when air passes over or through it, without further direct intervention.

When the airflow or wind abates, the movable part (flap element 104) of the bumper sticker (an exemplary product 100) that does not have a sticker backing, can still move, if air is moving and or until the next gust of wind or an increase in the airflow lifts the movable part (flap element 104) of the sticker in the air, and so on. The applications of products of the present disclosure include political affiliations, sporting teams, general sayings, driving instructions, quotes, personal greetings, religious affiliations, advertisements, cartoon characters, movies, and the like. At least one embodiment of the present disclosure is to get people's attention more than a stationary bumper sticker. Exemplary products 100 of the present disclosure can have portions comprising various materials, such as fabric, plastic, vinyl, magnetic, or any other movable material.

While various embodiments of products and methods for forming and using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A product configured to adhere to a vehicle, comprising:
an adherent portion; and
a flap element coupled to or formed as part of the adherent portion;
wherein the adherent portion is configured to adhere to a vehicle; and
wherein the flap element is configured to flap in the wind while the vehicle is moving.

2. The product of claim 1, wherein the adherent portion comprises one or more adhesives.

3. The product of claim 1, wherein the adherent portion comprises one or more magnets.

4. The product of claim 2, wherein the adherent portion further comprises one or more magnets.

5. The product of claim 2, wherein the adherent portion has indicia upon an outer surface of the adherent portion, and wherein the one or more adhesives are present upon an inner surface intended to contact the vehicle.

6. The product of claim 3, wherein the adherent portion has indicia upon an outer surface of the adherent portion, and wherein the one or more magnets are present upon an inner surface intended to contact the vehicle.

7. The product of claim 1, configured such that the flap element comprises hair or fur.

8. A product configured to adhere to a vehicle, comprising:
an adherent portion comprising an adherent selected from the group consisting of one or more adhesives and one or more magnets; and
a flap element coupled to or formed as part of the adherent portion;
wherein the adherent portion is configured to adhere to a vehicle;
wherein the flap element does not have one or more adhesives or one or more magnets that would cause the flap element to adhere to the vehicle; and
wherein the flap element is configured to flap in the wind while the vehicle is moving.

9. A method, comprising the steps of:
adhering the product of claim 8 to the vehicle; and
driving the vehicle to cause the flap element to flap in the wind while the vehicle is moving.
